(19) United States
(12) Patent Application Publication
(10) Pub. No.: US 2024/0417561 A1
(43) Pub. Date: Dec. 19, 2024

(54) High-Elastic Degradable Pickleball

(71) Applicant: MEMEDA LLC, Irvine, CA (US)

(72) Inventor: Weili Kong, Irvine, CA (US)

(21) Appl. No.: 18/533,019

(22) Filed: Dec. 7, 2023

(30) Foreign Application Priority Data
Jun. 16, 2023 (CN) 202310713192X
Jun. 16, 2023 (CN) 2023107136618

(51) Int. Cl. C08L 67/04

(52) U.S. Cl. CPC C08L 67/04; A63B 37/0098; A63B 2209/00; C08L 2205/03

(57) ABSTRACT

A high-elastic degradable pickleball is made from raw materials such as polylactic acid, polypropylene carbonate elastomer, and nanosilica, the pickleball prepared by the invention uses polylactic acid and polypropylene carbonate elastomer as basic raw materials, which can be completely biodegraded in nature, is environmentally friendly, pollution-free, and has both strength and toughness: it can withstand 2,000 beats without cracking or stretching; it has good resilience and moderate elasticity, when dropped from 1 m, its rebound height is no more than 40 or 45 centimeters.

### 1. TECHNICAL FIELD

The invention relates to the technical field of sports equipment, in particular to a high-elastic degradable pickleball.

### 2. BACKGROUND ART

Pickleball is a sport played by hitting a ball with a racket. Pickleball has less activity and exercise than tennis. People who can't play tennis well are suitable to play pickleball as a regular exercise program. Pickleball is suitable for people of all ages, especially those who used to play tennis but no longer have the conditions to continue playing, or individuals who play table tennis or badminton and are looking for a more intense sports activity. Pickleball is an excellent choice in such cases. The existing pickleballs are made of non-biodegradable plastic materials, such as polyethylene. When disposed of, old or unusable pickleballs cannot naturally degrade and can contribute to plastic pollution in the environment. Additionally, the durability of pickleballs in the market has been a concern, as they tend to deform, be unable to bounce back, and have poor elasticity after being hit for less than 2000 times.

### 3. SUMMARY OF THE INVENTION

Therefore, in view of the foregoing background, the invention provides a high-elastic degradable pickleball, which is not only fully biodegradable, but also has both strength and toughness.

The technical scheme of the invention is as follow:

A high-elastic degradable pickleball, wherein it is made from the following raw materials:

Polylactic acid 55%-65%, polypropylene carbonate elastomer 25%-40%, nanosilica 4%-10%, tetrabutyl titanate or 2,4-toluene diisocyanate 1%-3%.

Further, it is made from the following raw materials:
Polylactic acid 60%-65%, polypropylene carbonate elastomer 25%-30%, nanosilica 8%-10%, tetrabutyl titanate 1%-3%.

Further, it is made from the following raw materials:
Polylactic acid 55%-58%, polypropylene carbonate elastomer 32%-40%, nanosilica 4%-6%, 2,4-toluene diisocyanate 1%-3%.

Further, the polypropylene carbonate elastomer is made from the following raw materials: polypropylene carbonate diol, diphenylmethane diisocyanate and/or tetrabutyl titanate, 1,4-butanediol, and organic tin catalyst.

Further, the preparation steps of the polypropylene carbonate elastomer are as follows:
S1: Preprocessing raw materials
Filtering and drying raw materials such as polypropylene carbonate diol, diphenylmethane diisocyanate and 1,4-butanediol to ensure the purity and dryness of the raw materials;
S2: Preparing prepolymer
Mixing the pretreated polypropylene carbonate diol and diphenylmethane diisocyanate, adding the organic tin catalyst, and performing a mixing reaction at a temperature of 75-80° C. to prepare a prepolymer of polypropylene carbonate elastomer;
S3: Polypropylene carbonate elastomer
Mixing the prepolymer and 1,4-butanediol in proportion, heating to 55-65° C. under stirring conditions, and then it is extrude and pelletized.

Further, the mass ratio of polypropylene carbonate diol, diphenylmethane diisocyanate and/or tetrabutyl titanate in the raw materials for preparing the polypropylene carbonate elastomer in step S2 is 1:1.2;
Further, the amount of organo tin added in step S2 is 0.03% of the total weight of raw materials;
Further, the weight ratio of prepolymer to 1,4-butanediol added in step S3 is 1:0.6.
Further, the nanosilica needs to be modified, and the modification operation is as follow:
Using the silane and titanate coupling agent to perform surface activation treatment on nanosilica, during the treatment process, adding the oxidant, antiozonant and environmentally friendly plasticizer.

Further, the weights of the added oxidant, antiozonant and environmentally friendly plasticizer are respectively 0.02%, 0.2% and 5% of the amount of nanosilica;
Further, the oxidant is 2,6-di-tert-butyl-p-cresol and/or bisphenol A, the antiozonant is N, N′-diphenyl-p-phenylenediamine and/or N-isopropyl-N′-phenyl-p-phenylenediamine, the environmentally friendly plasticizer is epoxidized soybean oil.

Adopting the invention can achieve the following advantageous effects:
The pickleball prepared by the invention uses polylactic acid and polypropylene carbonate elastomer as basic raw materials, which can be completely biodegraded in nature, is environmentally friendly, pollution-free, and has both strength and toughness, and has strong impact resistance, it can withstand 2,000 beats without cracking or stretching; it has good resilience, when dropped from 1 m, its rebound height is no more than 40 or 45 centimeters.

### 4. SPECIFIC EMBODIMENT OF THE INVENTION

Reference to embodiments of the invention will now be provided in detail, one or more embodiments of which are described below. Each embodiment is provided by way of explanation, not limitation of the invention. In fact, it will be apparent to those skilled in the art that various modifications and variations can be made in the invention without departing from the scope or spirit of the invention. For example, features illustrated or described as part of one embodiment can be used in another embodiment to generate further embodiments.

Therefore, it is intended that the invention cover such modifications and variations as come within the scope of the appended claims and their equivalents. Other objects, features, and aspects of the invention are provided in, or are apparent from the following detailed description. Those of ordinary skill in the art should understand that this discussion is merely a description of exemplary embodiments and is not intended to limit the broader aspects of the invention. The invention will be further described below in combination with embodiments.

Embodiment 1: a high-elastic degradable pickleball, wherein it is made from the following raw materials:
Polylactic acid 30%, polypropylene carbonate elastomer 60%, nanosilica 8%, tetrabutyl titanate 2%.
Polypropylene carbonate elastomer
The preparation steps of the polypropylene carbonate elastomer are as follows:
S1: Preprocessing raw materials
Filtering and drying raw materials such as polypropylene carbonate diol, diphenylmethane diisocyanate and 1,4-butanediol to ensure the purity and dryness of the raw materials;
S2: Preparing prepolymer
Mixing the pretreated polypropylene carbonate diol and diphenylmethane diisocyanate in a weight ratio of 1:1.2, adding the organic tin catalyst accounting for 0.03% of the total weight of raw materials, and performing a mixing reaction at a temperature of 80° C. to prepare a prepolymer of polypropylene carbonate elastomer;
S3: Polypropylene carbonate elastomer
Mixing the prepolymer and 1,4-butanediol at a ratio of 1:0.6, heating to 60° C. under stirring conditions, and then it is extrude and pelletized.

The nanosilica needs to be modified, and the modification operation is as follow:
Using the silane and titanate coupling agent to perform surface activation treatment on nanosilica, during the treatment process, adding the oxidant, antiozonant and environmentally friendly plasticizer.

The weights of the added oxidant, antiozonant and environmentally friendly plasticizer are respectively 0.02%, 0.2% and 5% of the amount of nanosilica;

The oxidant is 2,6-di-tert-butyl-p-cresol (BHT) and/or bisphenol A, the antiozonant is N, N′-diphenyl-p-phenylenediamine (DPPD) and/or N-isopropyl-N′-phenyl-p-phenylenediamine, the environmentally friendly plasticizer is epoxidized soybean oil.

The pickleball prepared in this embodiment has very good resilience, but the surface is slightly soft, its performance: (1) when dropped from 1 m, its rebound height is no more than 40 centimeters. (2) it can withstand 2,000 beats without cracking or stretching.

Embodiment 2: a high-elastic degradable pickleball, wherein it is made from the following raw materials: Polylactic acid 58%, polypropylene carbonate elastomer 34%, nanosilica 6%, 2,4-toluene diisocyanate 2%.

### Polypropylene Carbonate Elastomer

The preparation steps of the polypropylene carbonate elastomer are as follows:
S1: Preprocessing raw materials
Filtering and drying raw materials such as polypropylene carbonate diol, diphenylmethane diisocyanate and 1,4-butanediol to ensure the purity and dryness of the raw materials;
S2: Preparing prepolymer
Mixing the pretreated polypropylene carbonate diol and diphenylmethane diisocyanate in a weight ratio of 1:1.2, adding the organic tin catalyst accounting for 0.03% of the total weight of raw materials, and performing a mixing reaction at a temperature of 80° C. to prepare a prepolymer of polypropylene carbonate elastomer;
S3: Polypropylene carbonate elastomer
Mixing the prepolymer and 1,4-butanediol at a ratio of 1:0.6, heating to 60° C. under stirring conditions, and then it is extrude and pelletized.
The nanosilica needs to be modified, and the modification operation is as follow:
Using the silane and titanate coupling agent to perform surface activation treatment on nanosilica, during the treatment process, adding the oxidant, antiozonant and environmentally friendly plasticizer.

The weights of the added oxidant, antiozonant and environmentally friendly plasticizer are respectively 0.02%, 0.2% and 5% of the amount of nanosilica;

The oxidant is 2,6-di-tert-butyl-p-cresol (BHT) and/or bisphenol A, the antiozonant is N, N′-diphenyl-p-phenylenediamine (DPPD) and/or N-isopropyl-N′-phenyl-p-phenylenediamine, the environmentally friendly plasticizer is epoxidized soybean oil.

The pickleball prepared in this embodiment has relatively good resilience, high surface hardness, its performance: (1) when dropped from 1 m, its rebound height is no more than 45 centimeters; (2) it can withstand 2,000 beats without cracking or stretching.

The preparation of the pickleball using the raw materials in Embodiment 1 to Embodiment 2 can be carried out by a rotational molding process or an injection molding process.

Any other matters not mentioned in the invention are well known to those skilled in the art in this field.

The technical features of the above-described embodiments can be combined in any way. To simplify the description, not all possible combinations of the technical features in the above-described embodiments are described. However, as long as there is no contradiction in the combination of these technical features, they should be considered to be within the scope of this specification.

1. A high-elastic degradable pickleball, wherein it is made from the following raw materials:
Polylactic acid 55%-65%, polypropylene carbonate elastomer 25%-40%, nanosilica 4%-10%, tetrabutyl titanate or 2,4-toluene diisocyanate 1%-3%.

2. A high-elastic degradable pickleball of claim 1, wherein:
It is made from the following raw materials:
Polylactic acid 60%-65%, polypropylene carbonate elastomer 25%-30%, nanosilica 8%-10%, tetrabutyl titanate 1%-3%.

3. A high-elastic degradable pickleball of claim 1, wherein:
It is made from the following raw materials:
Polylactic acid 55%-58%, polypropylene carbonate elastomer 32%-40%, nanosilica 4%-6%, 2,4-toluene diisocyanate 1%-3%.

4. A high-elastic degradable pickleball of claim 1, wherein:
The polypropylene carbonate elastomer is made from the following raw materials:
polypropylene carbonate diol, diphenylmethane diisocyanate, 1,4-butanediol, and organic tin catalyst.

5. A high-elastic degradable pickleball of claim 4, wherein the preparation steps of the polypropylene carbonate elastomer are as follows:
S1: Preprocessing raw materials
Filtering and drying raw materials such as polypropylene carbonate diol, diphenylmethane diisocyanate and 1,4-butanediol to ensure the purity and dryness of the raw materials;
S2: Preparing prepolymer
Mixing the pretreated polypropylene carbonate diol and diphenylmethane diisocyanate, adding the organic tin catalyst, and performing a mixing reaction at a temperature of 75-80° C. to prepare a prepolymer of polypropylene carbonate elastomer;
S3: Polypropylene carbonate elastomer
Mixing the prepolymer and 1,4-butanediol in proportion, heating to 55-65° C. under stirring conditions, and then it is extrude and pelletized.

6. A high-elastic degradable pickleball of claim 5, wherein: the mass ratio of polypropylene carbonate diol, diphenylmethane diisocyanate and/or tetrabutyl titanate in the raw materials for preparing the polypropylene carbonate elastomer in step S2 is 1:1.2;
The amount of organo tin added in step S2 is 0.03% of the total weight of raw materials;
The weight ratio of prepolymer to 1,4-butanediol added in step S3 is 1:0.6.

7. A high-elastic degradable pickleball of claim 1, wherein: the nanosilica needs to be modified, and the modification operation is as follow:
Using the silane and titanate coupling agent to perform surface activation treatment on nanosilica, during the treatment process, adding the oxidant, antiozonant and environmentally friendly plasticizer.

8. A high-elastic degradable pickleball of claim 7, wherein:
The weights of the added oxidant, antiozonant and environmentally friendly plasticizer are respectively 0.02%, 0.2% and 5% of the amount of nanosilica; the oxidant is 2,6-di-tert-butyl-p-cresol and/or is N, bisphenol A, the antiozonant N′-diphenyl-p-phenylenediamine and/or N-isopropyl-N′-phenyl-p-phenylenediamine, the environmentally friendly plasticizer is epoxidized soybean oil.
